(19) United States
(12) Patent Application Publication
(10) Pub. No.: US 2024/0416499 A1
(43) Pub. Date: Dec. 19, 2024

(54) Heated Toolbox Device

(71) Applicant: Michal Eberle, Shannon, IL (US)

(72) Inventor: Michal Eberle, Shannon, IL (US)

(21) Appl. No.: 18/209,775

(22) Filed: Jun. 14, 2023

(51) Int. Cl. B25H 3/02; H05B 3/26

(52) U.S. Cl. CPC B25H 3/02; H05B 3/26

(57) ABSTRACT

A heated toolbox device for storing perishable materials and battery chargers at a construction site includes a storage box defining a storage space and a lid hingedly coupled to the storage box for closing the storage space. A pair of shelves is releasably attachable to the storage box to support a battery charger. A plurality of electrical outlets is integrated into the storage box to receive a power cord of a respective one of the battery chargers. A heating element is integrated into the storage box to warm the storage box when the heating element is turned on. In this way the heating element inhibits the perishable construction materials and the battery chargers from being exposed to freezing temperatures.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toolbox devices and more particularly pertains to a new tool box device for storing perishable construction materials and battery chargers in a cold environment. The device includes a toolbox, a heating element integrated into the toolbox for warming the toolbox, a plurality of storage spaces located in the toolbox for storing perishable construction materials and a plurality of electrical outlets integrated into an interior of the toolbox for powering battery chargers.

### (2) Description of Related Art Including Information Disclosed Under 37 CFR 1.97 and 1.98

The prior art relates to toolbox devices including a variety of storage boxes with passive heating elements and a heated toolbox that includes charging ports for rechargeable batteries. In no instance does the prior art disclose a heated toolbox that includes electrical outlets integrated into an interior of the heated toolbox.

### BRIEF SUMMARY OF THE INVENTION

An embodiment of the disclosure meets the needs presented above by generally comprising a storage box defining a storage space and a lid hingedly coupled to the storage box for closing the storage space. A pair of shelves is releasably attachable to the storage box to support a battery charger. A plurality of electrical outlets is integrated into the storage box to receive a power cord of a respective one of the battery chargers. A heating element is integrated into the storage box to warm the storage box when the heating element is turned on. In this way the heating element inhibits the perishable construction materials and the battery chargers from being exposed to freezing temperatures.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a heated toolbox device according to an embodiment of the disclosure.

FIG. 2 is a front view of an embodiment of the disclosure.

FIG. 3 is a bottom phantom view of an embodiment of the disclosure.

FIG. 4 is a top view of an embodiment of the disclosure showing a lid in an open position.

FIG. 5 is a back view of an embodiment of the disclosure.

FIG. 6 is a cross sectional view taken along line 6-6 of FIG. 1 of an embodiment of the disclosure.

FIG. 7 is a left side view of an embodiment of the disclosure.

FIG. 8 is a cross sectional view taken along line 8-8 of FIG. 2 of an embodiment of the disclosure.

FIG. 9 is a schematic view of an embodiment of the disclosure.

### DETAILED DESCRIPTION OF THE INVENTION

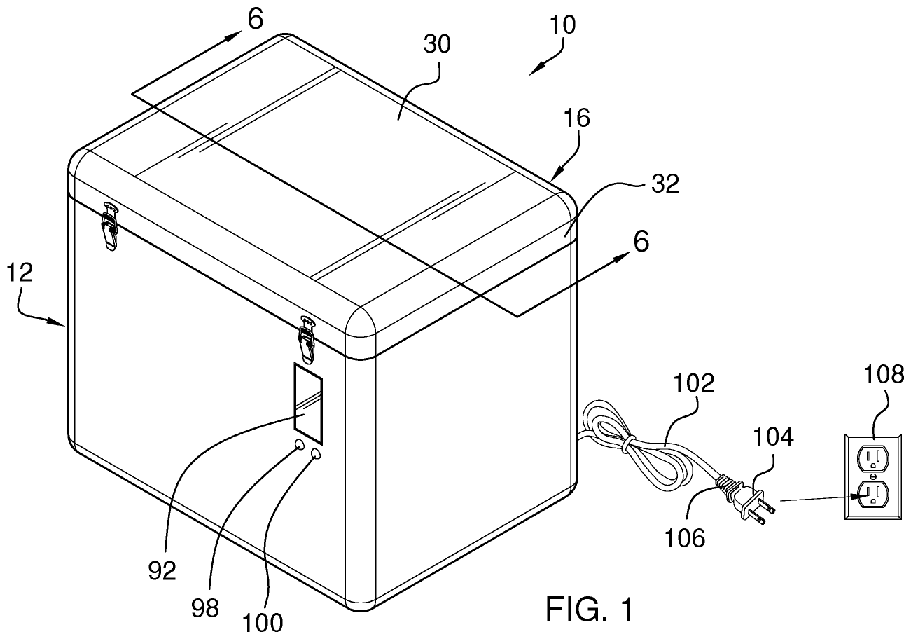

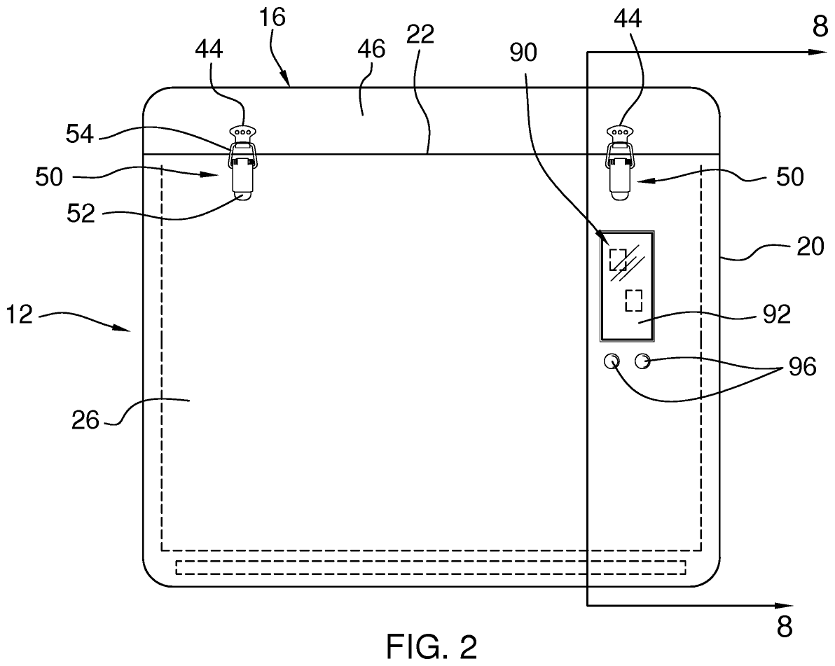

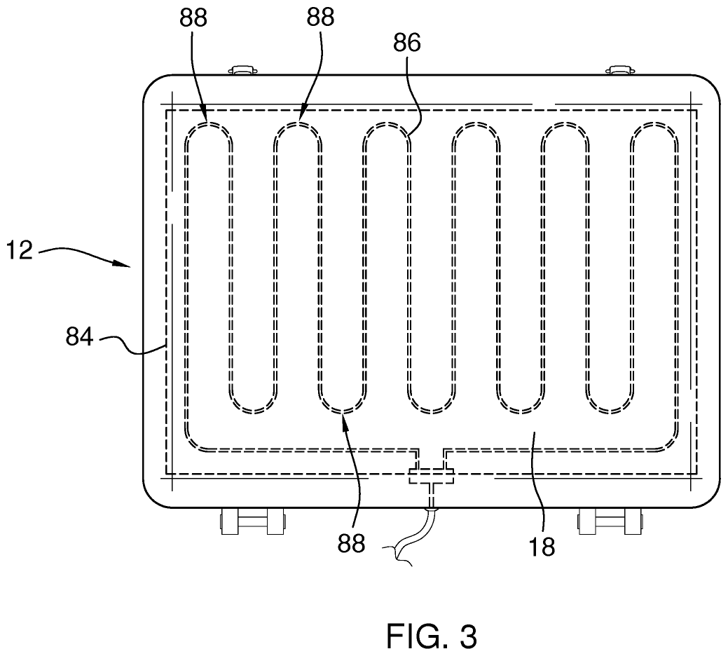

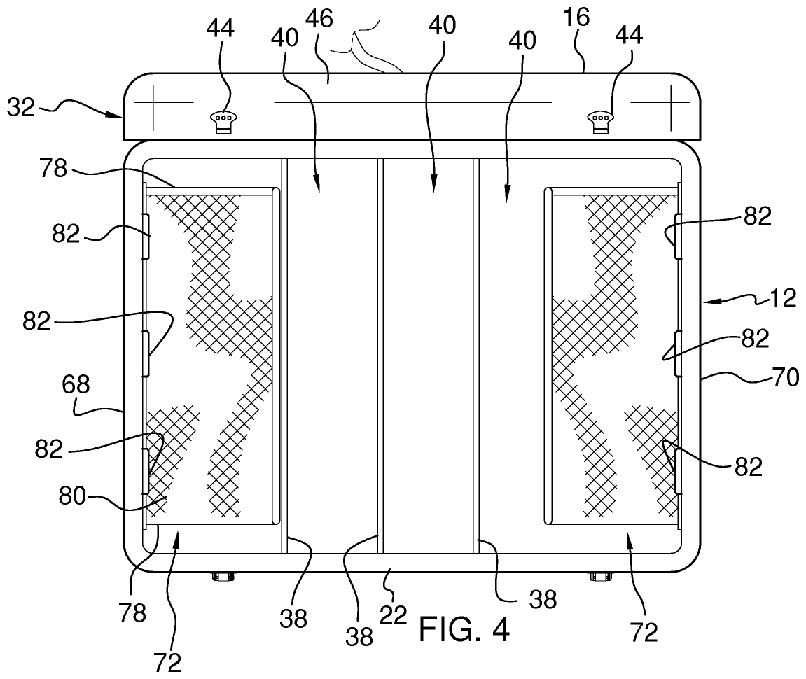

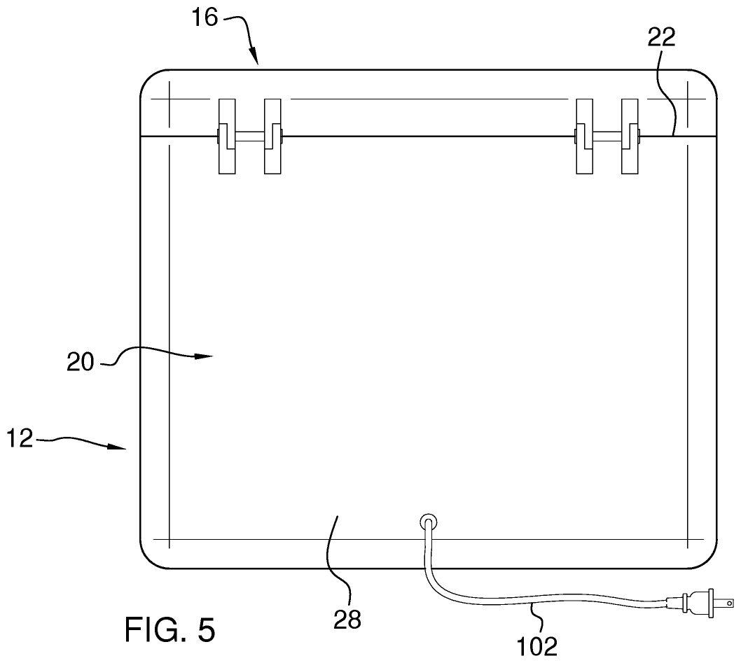

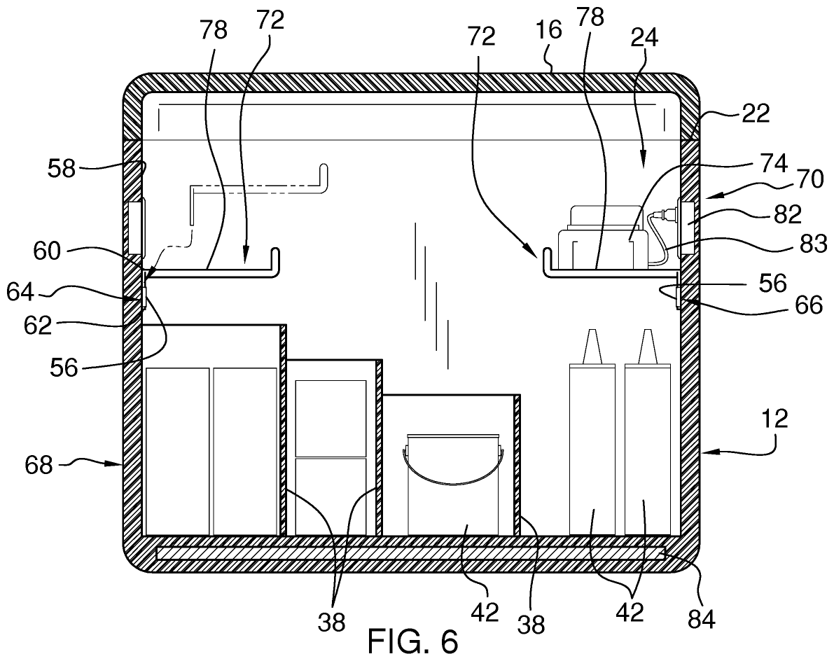

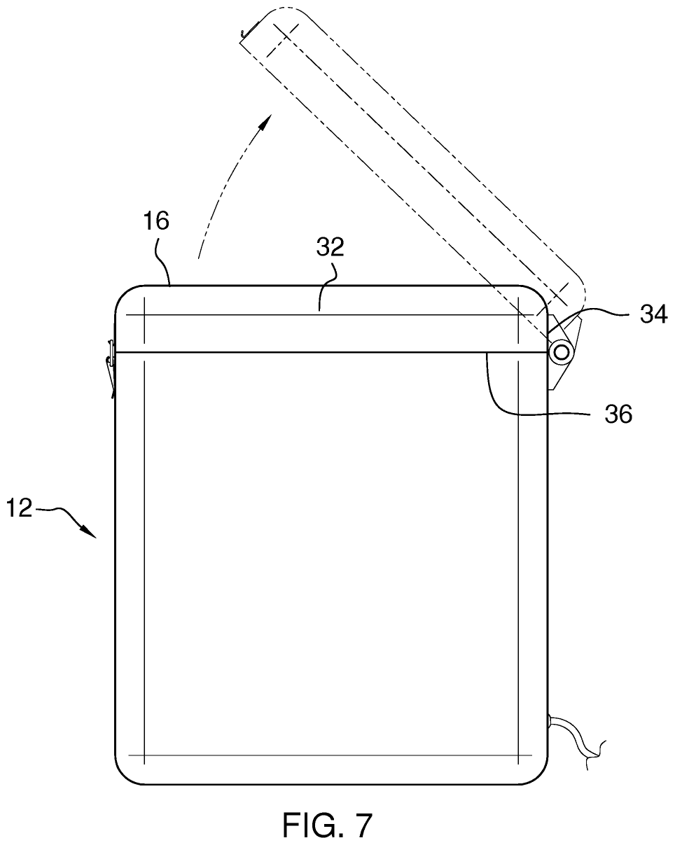

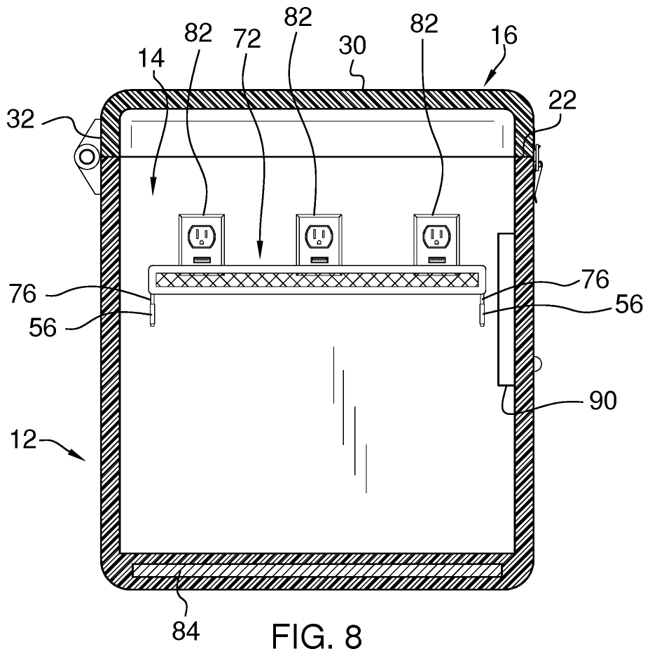

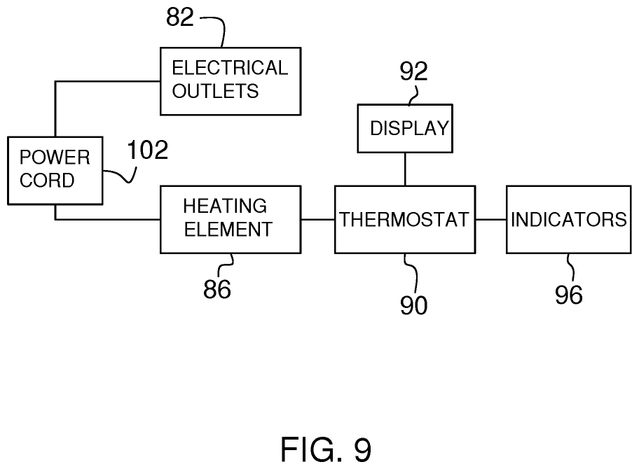

With reference now to the drawings, and in particular to FIGS. 1 through 9 thereof, a new toolbox device embodying the principles and concepts of an embodiment of the disclosure and generally designated by the reference numeral 10 will be described.

As best illustrated in FIGS. 1 through 9, the heated toolbox device 10 generally comprises a storage box 12 which defines a storage space 14 and a lid 16 that is hingedly coupled to the storage box 12 for closing the storage space 14. Each of the storage box 12 and the lid 16 is comprised of a thermally insulating material to inhibit thermal communication between ambient air and the storage space 14. The storage box 12 has a bottom wall 18 and an outside wall 20 extending upwardly from the bottom wall 18; the outside wall 20 has a top edge 22 defining an opening 24 into the storage space 14 and the outside wall 20 has a front side 26 and a back side 28. The lid 16 has a top wall 30 and a perimeter wall 32 extending downwardly from the top wall 30. The perimeter wall 32 has a rear side 34 and a bottom edge 36 and the rear side 34 of the perimeter wall 32 is hingedly coupled to the back side 28 of the outside wall 20 of the storage box 12; the bottom edge 36 rests on the top edge 22 when the lid 16 is closed. The storage box 12 and the lid 16 are comprised of a rigid and resilient material, such as high impact plastic for example, that can resist being damaged by daily use on a construction site.

The storage box 12 has a plurality of dividing walls 38 each extending between the front side 26 and the back side 28 of the outside wall 20 to define a plurality storage spaces 40 between respective dividing walls 38 for storing perishable construction materials 42. Each of the plurality of dividing walls 38 has a unique height with respect to each other. Furthermore, the plurality of dividing walls 38 is laterally distributed on the bottom wall 18 of the storage box 12 from tallest to shortest. The perishable construction materials 42 may include, but not be limited to, paint and caulk and adhesives and other materials that can be destroyed by being exposed to freezing temperatures.

A pair of hooks 44 is each coupled to a forward side 46 of the perimeter wall 32 of the lid 16. A pair of locks 50 is provided and each of the locks 50 includes a lever 52 that is pivotally coupled to the front side 26 of the outside wall 20 of the storage box 12. Each of the locks 50 includes a looped member 54 that is pivotally attached to the lever 52. The looped member 54 of a respective one of the locks 50 is positionable to pull downwardly on a respective one of the hooks 44 when the lever 52 of respective lock 50 is urged into a locking position for retaining the lid 16 in a closed position. Conversely, the looped member 54 of the respective lock 50 is urged upwardly to disengage the respective hook 44 when the lever 52 of the respective lock 50 is urged into an unlocking position to facilitate the lid 16 to be positioned in an open position.

A plurality of sleeves 56 is provided and each of the sleeves 56 is attached to an inside surface 58 of the outside wall 20 of the storage box 12. Each of the plurality of sleeves 56 has an upper end 60 that is open and a lower end 62 that is open. The plurality of sleeves 56 includes a set of first sleeves 64 and a set of second sleeves 66. Each of the first sleeves 64 is laterally distributed along a first lateral side 68 of the outside wall 20 and each of the second sleeves 66 is laterally distributed along a second lateral side 70 of the outside wall 20.

A pair of shelves 72 is provided and each of the shelves 72 is releasably attachable to the storage box 12 to support a battery charger 74. The battery charger 74 may be a battery charger for a cordless drill, for example, or any other type of battery charger that would commonly be found on a construction site. Each of the shelves 72 includes a pair of feet 76 extending downwardly from a respective one of a pair of lateral members 78. Each of the feet 76 of a respective one of the shelves 72 is slidable into the upper end 60 of a respective one of the sleeves 56 having the lateral members 78 being horizontally oriented. Each of the shelves 72 includes a mesh panel 80 which extends between the pair of lateral members 78 to support the battery charger 74. The mesh panel 80 associated with each of the shelves 72 may be comprised of a rigid material, including but not being limited to steel or plastic, for supporting the weight of the battery charger 74 and a battery being charged by the battery charger 74.

A plurality of electrical outlets 82 is provided and each of the plurality of electrical outlets 82 is integrated into the storage box 12. Each of the plurality of electrical outlets 82 is positioned in the storage space 14 to receive a power cord 83 of a respective one of the battery chargers 74. Each of the plurality of electrical outlets 82 is integrated into the inside surface 58 of the outside wall 20 of the storage box 12. Additionally, each of the plurality of electrical outlets 82 is positioned between the top edge 22 of the outside wall 20 of the storage box 12 and respective ones of the first sleeves 64 and the second sleeves 66. Each of the plurality of electrical outlets 82 may comprise a three prong female electrical outlet or the like.

A mat 84 is provided and the mat 84 is integrated into the bottom wall 18 of the storage box 12. The mat 84 is comprised of a thermally conductive material such that the mat 84 is in thermal communication with the bottom wall 18. Additionally, the mat 84 covers a substantial length and width of the bottom wall 18. A heating element 86 is integrated into the storage box 12 and the heating element 86 is in thermal communication with the storage box 12. In this way the heating element 86 can warm the storage box 12 when the heating element 86 is turned on. Thus, the heating element 86 inhibits the perishable construction materials 42 and the battery chargers 74 from being exposed to freezing temperatures. The heating element 86 is integrated into the mat 84 in the bottom wall 18 of the storage box 12 and the heating element 86 comprises a plurality of coils 88 distributed along a full width of the mat 84. Furthermore, the heating element 86 may comprise an electric heating element with an operational temperature ranging between approximately 40.0 degrees fahrenheit and 80.0 degrees fahrenheit.

A thermostat 90 is integrated into the outside wall 20 of the storage box 12 and the thermostat 90 is in thermal communication with the storage space 14 to detect the temperature of the storage space 14. The thermostat 90 is electrically coupled to the heating element 86 for controlling an operational temperature of the heating element 86. Additionally, the thermostat 90 includes a display 92 that is exposed on an outside surface 94 of the outside wall 20 which displays indicia 94 comprising numbers to indicate the temperature of the storage space 14. The display 92 may comprise a touch screen display such as a liquid crystal display or the like and the thermostat 90 may comprise a digital thermostat. Furthermore, the display 92 may be employed to set the operational temperature of the heating element 86.

A pair of indicators 96 is each coupled to the outside surface of the outside wall 20 and each of the indicators 96 is electrically coupled to the thermostat 90. A first one of the indicators 98 is turned on when the heating element 86 is turned on. Conversely, each of the first indicator 98 and a second one of the indicators 100 is turned on when the thermostat 90 detects the temperature in the storage space 14 has reached a pre-determined maximum temperature. Each of the indicators 96 may comprise a light emitter or other type of visual alert and each of the indicators 96 may emit light of a unique color with respect to each other. The heating element 86 is turned off when the thermostat 90 detects the pre-determined maximum temperature. Conversely, the heating element 86 is turned on when the thermostat 90 detects the temperature in the storage space 14 has reached a pre-determined minimum temperature.

A power cord 102 is coupled to and extends away from the outside wall 20 of the storage box 12. The power cord 102 is electrically coupled to the heating element 86 and each of the plurality of electrical outlets 82. Additionally, the power cord 102 has a male plug 104 that is electrically coupled to a distal end 106 of the power cord 102. In this way the male plug 104 can be plugged into a power source 108 which comprises a female electrical outlet.

In use, the perishable construction materials 42 are stored in the respective storage spaces 40 in the storage box 12 and each of the shelves 72 is attached to the outside wall 20 of the storage box 12. The power cord 102 is plugged into the power source 108 and to facilitate the heating element 86 to warm the storage space 14 in the storage box 12. In this way the perishable construction materials 42 are inhibited from freezing when ambient temperatures fall below the freezing point of water. Thus, the perishable construction materials 42 can be safely stored at a construction site that does not have heat during winter months. Furthermore, the battery chargers 74 can be positioned on the shelves 72 such that the battery chargers 74 are kept warm. In this way the battery chargers 74 can properly charge the rechargeable batteries in spite of the cold temperatures.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated toolbox device for facilitating electronic tools and perishable construction materials to be stored in a heated environment to inhibit the electronic tools and perishable construction materials from freezing, said device comprising:
a storage box defining a storage space and a lid hingedly coupled to said storage box for closing said storage space, each of said storage box and said lid being comprised of a thermally insulating material wherein each of said storage box and said lid are configured to inhibit thermal communication between ambient air and said storage space;
a pair of shelves, each of said shelves being releasably attachable to said storage box wherein each of said shelves is configured to support a battery charger;
a plurality of electrical outlets, each of said plurality of electrical outlets being integrated into said storage box, each of said plurality of electrical outlets being positioned in said storage space wherein each of said plurality of electrical outlets is configured to receive a power cord of a respective one of the battery chargers; and
a heating element being integrated into said storage box, said heating element being in thermal communication with said storage box thereby facilitating said heating element to warm said storage box when said heating element is turned on wherein said heating element is configured to inhibit the perishable construction materials and the battery chargers from being exposed to freezing temperatures.

2. The assembly according to claim 1, wherein:
said storage box has a bottom wall and an outside wall extending upwardly from said bottom wall, said outside wall having a top edge defining an opening into said storage space, said outside wall having a front side and a back side;
said lid has a top wall and a perimeter wall extending downwardly from said top wall, said perimeter wall having a rear side and a bottom edge, said rear side of said perimeter wall being hingedly coupled to said back side of said outside wall of said storage box, said bottom edge resting on said top edge when said lid is closed; and
said storage box has a plurality of dividing walls each extending between said front side and said back side of said outside wall to define a plurality storage spaces between respective dividing walls wherein each of said plurality of storage spaces is configured to store perishable construction materials, each of said plurality of dividing walls having a unique height with respect to each other, said plurality of dividing walls being laterally distributed on said bottom wall of said storage box from tallest to shortest.

3. The assembly according to claim 2, further comprising:
a pair of hooks, each of said hooks being coupled to a forward side of said exterior wall of said lid; and
a pair of locks, each of said locks including a lever being pivotally coupled to said front side of said outer wall of said storage box, each of said locks including a looped member being pivotally attached to said lever, said looped member of a respective one of said locks being positionable to pull downwardly on a respective one of said hooks when said lever of respective lock is urged into a locking position for retaining said lid in a closed position, said looped member of said respective lock being urged upwardly to disengage said respective hook when said lever of said respective lock is urged into an unlocking position to facilitate said lid to be positioned in an open position.

4. The assembly according to claim 2, further comprising a plurality of sleeves, each of said sleeves being attached to an inside surface of said outside wall of said storage box, each of said plurality of sleeves having an upper end being open and a lower end being open, said plurality of sleeves including a set of first sleeves and a set of second sleeves, each of said first sleeves being laterally distributed along a first lateral side of said outside wall, each of said second sleeves being laterally distributed along a second lateral side of said outside wall.

5. The assembly according to claim 4, wherein each of said shelves includes a pair of feet extending downwardly from a respective one of a pair of lateral members, each of said feet of a respective one of said shelves being slidable into said upper end of a respective one of said sleeves having said lateral members being horizontally oriented, each of said shelves including a mesh panel extending between said pair of lateral members wherein said mesh panel is configured to support the battery charger.

6. The assembly according to claim 3, wherein each of said plurality of electrical outlets is integrated into said inside surface of said outside wall of said storage box, each of said plurality of electrical outlets is positioned between said top edge of said outside wall of said storage box and respective ones of said first sleeves and said second sleeves.

7. The assembly according to claim 2, further comprising a mat being integrated into said bottom wall of said storage box, said mat being comprised of a thermally conductive material such that said mat is in thermal communication with said bottom wall, said mat covering a substantial length and width of said bottom wall.

8. The assembly according to claim 7, wherein said heating element is integrated into said mat in said bottom wall of said storage box, said heating element comprising a plurality of coils being distributed along a full width of said mat.

9. The assembly according to claim 2, further comprising a thermostat being integrated into said outside wall of said storage box, said thermostat being in thermal communication with said storage space wherein said thermostat is configured to detect the temperature of said storage space, said thermostat being electrically coupled to said heating element for controlling an operational temperature of said heating element, said thermostat including a display being exposed on an outside surface of said outside wall, said display displaying indicia comprising numbers to indicate the temperature of said storage area.

10. The assembly according to claim 9, further comprising a pair of indicators, each of said indicators being coupled to said outside surface of said outside wall, each of said indicators being electrically coupled to said thermostat, a first one of said indicators being turned on when said heating element is turned on, each of said first indicator and a second one of said indicators being turned on when said thermostat detects the temperature in said storage area has reached a pre-determined maximum temperature, said heating element being turned off when said thermostat detects the pre-determined maximum temperature, said heating element being turned on when said thermostat detects the temperature in said storage area has reached a pre-determined minimum temperature.

11. The assembly according to claim 2, further comprising a power cord being coupled to and extending away from said outside wall of said storage box, said power cord being electrically coupled to said heating element and each of said plurality of electrical outlets, said power cord having a male plug being electrically coupled to a distal end of said power cord wherein said male plug is configured to be plugged into a power source comprising a female electrical outlet.

12. A heated toolbox device for facilitating electronic tools and perishable construction materials to be stored in a heated environment to inhibit the electronic tools and perishable construction materials from freezing, said device comprising:
a storage box defining a storage space and a lid hingedly coupled to said storage box for closing said storage space, each of said storage box and said lid being comprised of a thermally insulating material wherein each of said storage box and said lid are configured to inhibit thermal communication between ambient air and said storage space, said storage box having a bottom wall and an outside wall extending upwardly from said bottom wall, said outside wall having a top edge defining an opening into said storage space, said outside wall having a front side and a back side, said lid having a top wall and a perimeter wall extending downwardly from said top wall, said perimeter wall having a rear side and a bottom edge, said rear side of said perimeter wall being hingedly coupled to said back side of said outside wall of said storage box, said bottom edge resting on said top edge when said lid is closed, said storage box having a plurality of dividing walls each extending between said front side and said back side of said outside wall to define a plurality storage spaces between respective dividing walls wherein each of said plurality of storage spaces is configured to store perishable construction materials, each of said plurality of dividing walls having a unique height with respect to each other, said plurality of dividing walls being laterally distributed on said bottom wall of said storage box from tallest to shortest;
a pair of hooks, each of said hooks being coupled to a forward side of said exterior wall of said lid;
a pair of locks, each of said locks including a lever being pivotally coupled to said front side of said outer wall of said storage box, each of said locks including a looped member being pivotally attached to said lever, said looped member of a respective one of said locks being positionable to pull downwardly on a respective one of said hooks when said lever of respective lock is urged into a locking position for retaining said lid in a closed position, said looped member of said respective lock being urged upwardly to disengage said respective hook when said lever of said respective lock is urged into an unlocking position to facilitate said lid to be positioned in an open position;
a plurality of sleeves, each of said sleeves being attached to an inside surface of said outside wall of said storage box, each of said plurality of sleeves having an upper end being open and a lower end being open, said plurality of sleeves including a set of first sleeves and a set of second sleeves, each of said first sleeves being laterally distributed along a first lateral side of said outside wall, each of said second sleeves being laterally distributed along a second lateral side of said outside wall;
a pair of shelves, each of said shelves being releasably attachable to said storage box wherein each of said shelves is configured to support a battery charger, each of said shelves including a pair of feet extending downwardly from a respective one of a pair of lateral members, each of said feet of a respective one of said shelves being slidable into said upper end of a respective one of said sleeves having said lateral members being horizontally oriented, each of said shelves including a mesh panel extending between said pair of lateral members wherein said mesh panel is configured to support the battery charger;
a plurality of electrical outlets, each of said plurality of electrical outlets being integrated into said storage box, each of said plurality of electrical outlets being positioned in said storage space wherein each of said plurality of electrical outlets is configured to receive a power cord of a respective one of the battery chargers, each of said plurality of electrical outlets being integrated into said inside surface of said outside wall of said storage box, each of said plurality of electrical outlets being positioned between said top edge of said outside wall of said storage box and respective ones of said first sleeves and said second sleeves;
a mat being integrated into said bottom wall of said storage box, said mat being comprised of a thermally conductive material such that said mat is in thermal communication with said bottom wall, said mat covering a substantial length and width of said bottom wall;
a heating element being integrated into said storage box, said heating element being in thermal communication with said storage box thereby facilitating said heating element to warm said storage box when said heating element is turned on wherein said heating element is configured to inhibit the perishable construction materials and the battery chargers from being exposed to freezing temperatures, said heating element being integrated into said mat in said bottom wall of said storage box, said heating element comprising a plurality of coils being distributed along a full width of said mat;
a thermostat being integrated into said outside wall of said storage box, said thermostat being in thermal communication with said storage space wherein said thermostat is configured to detect the temperature of said storage space, said thermostat being electrically coupled to said heating element for controlling an operational temperature of said heating element, said thermostat including a display being exposed on an outside surface of said outside wall, said display displaying indicia comprising numbers to indicate the temperature of said storage area;
a pair of indicators, each of said indicators being coupled to said outside surface of said outside wall, each of said indicators being electrically coupled to said thermostat, a first one of said indicators being turned on when said heating element is turned on, each of said first indicator and a second one of said indicators being turned on when said thermostat detects the temperature in said storage area has reached a pre-determined maximum temperature, said heating element being turned off when said thermostat detects the pre-determined maximum temperature, said heating element being turned on when said thermostat detects the temperature in said storage area has reached a pre-determined minimum temperature; and
a power cord being coupled to and extending away from said outside wall of said storage box, said power cord being electrically coupled to said heating element and each of said plurality of electrical outlets, said power cord having a male plug being electrically coupled to a distal end of said power cord wherein said male plug is configured to be plugged into a power source comprising a female electrical outlet.
